(19) United States
(12) Patent Application Publication
(10) Pub. No.: US 2024/0272446 A1
(43) Pub. Date: Aug. 15, 2024

(54) CAMERA BEAMSPLITTER MIRROR ASSEMBLY FOR ENHANCED EYE CONTACT IN DIGITAL COMMUNICATIONS

(71) Applicant: Daniel Alexander Kunz, Bellmund (CH)

(72) Inventor: Daniel Alexander Kunz, Bellmund (CH)

(21) Appl. No.: 18/108,023

(22) Filed: Feb. 10, 2023

(51) Int. Cl. G02B 27/14; G03B 17/56; H04N 23/54

(52) U.S. Cl. CPC G02B 27/144; G03B 17/561; H04N 23/54

(57) ABSTRACT

The present invention discloses a camera beamsplitter mirror assembly for enhanced eye contact in digital communications. The camera beamsplitter mirror assembly comprises of a display device for displaying a plurality of information, a beamsplitter mirror positioned in front of the display device, wherein the beamsplitter mirror is adjustable to a plurality of predetermined angles and an adjustable camera mounted to the display device by a removable attachment means, wherein the adjustable camera is pointed towards the reflective surface of the beamsplitter mirror. It further comprises a background component attachable to the beamsplitter mirror to provide a dark background behind the reflected image for enhanced contrast, wherein the background component can be adjusted to provide different color or effects. Overall, the adjustable camera and the beam splitter are positioned such that the person looking through the mirror is able to make direct eye contact with the camera.

### FIELD OF INVENTION

The present invention relates to the field of digital communications such as video conferencing, digital content presentation, and eye contact enhancement. More particularly, the present invention relates to a camera beamsplitter mirror assembly for enhanced eye contact in digital communications between a speaker and the audience or between the participants in a video conference.

### BACKGROUND OF THE INVENTION

Growing demand for effective communication and interaction in remote work and remote learning environments has driven rapid growth in the field of video conferencing and digital content presentation. One of the challenges in these types of applications is to establish eye contact between the speaker and the audience or between the participants in a video conference to provide an engaging and authentic communication experience.

Conventional solutions to establish eye contact during video conferencing or digital content presentation include teleprompters, which use beamsplitter mirrors to reflect the content on a dedicated monitor into the camera's lens. However, these solutions require a dedicated monitor or tablet device, which may not always be readily available or feasible in a typical work environment.

Further, most cameras used in video conferencing and other remote communication electronic devices are positioned above the monitor or screen, leading to an unnatural and awkward gaze, as the person is looking below or away from the camera, which causes a disconnect in communication and impacts the overall experience.

Therefore, in order to address this technical problem, it is desired to have a camera beamsplitter assembly that facilitates a simple, flexible, and cost-effective solution for improved eye contact in digital communications.

### SUMMARY OF THE INVENTION

In light of the requirements mentioned in the previous section, the following summary is provided to facilitate an understanding of some of the innovative features unique to the present invention and is not intended to be a full description. A full appreciation of the various aspects of the invention can be gained by taking the entire specification and drawings as a whole.

Embodiments of the present invention disclose a camera beamsplitter mirror assembly for enhanced eye contact in digital communications. The camera beamsplitter mirror assembly comprises of a display device for displaying a plurality of information, a beamsplitter mirror positioned in front of the display device, wherein the beamsplitter mirror is adjustable to a plurality of predetermined angles and an adjustable camera mounted to the display device by a removable attachment means, wherein the adjustable camera is pointed towards the reflective surface of the beamsplitter mirror.

According to an embodiment of the present disclosure, the beamsplitter mirror reflects an image of a person positioned in front of the camera beamsplitter mirror assembly to the adjustable camera.

According to an embodiment of the present disclosure, the camera beamsplitter mirror assembly further comprises a background component attachable to the beamsplitter mirror to provide a dark background behind the reflected image for enhanced contrast, wherein the background component can be adjusted to provide different colors or effects.

According to an embodiment of the present disclosure, the beamsplitter mirror is positioned at the plurality of predetermined angles ranging between 15° to 65°, preferably positioned at the angle of 45°. Further, the removable attachment means comprises at least one of a clip, clamp or bracket arm to facilitate attachment to the edge of the display device.

According to an embodiment of the present invention, the adjustable camera is pointed towards the reflective surface of the beamsplitter mirror captures the reflection of a person looking through the mirror onto the display device. Overall, the adjustable camera and the beam splitter are positioned such that the person looking through the mirror is able to make direct eye contact with the camera.

This summary is provided merely for the purposes of summarizing some example embodiments, to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

The abovementioned embodiments and further variations of the proposed invention are discussed further in the detailed description.

### BRIEF DESCRIPTION OF THE DRAWINGS

FIG. 1A illustrates a front view of a camera beamsplitter mirror assembly according to the embodiments of the present disclosure.

FIG. 1B is a schematic illustration of the camera beamsplitter mirror assembly according to the embodiments of the present disclosure.

FIG. 2A illustrates a perspective view of the camera beamsplitter mirror assembly with an adjustable camera titled downwards onto the beamsplitter mirror according to the embodiments of the present disclosure.

FIG. 2B illustrates the perspective view of the camera beamsplitter mirror assembly with the adjustable camera titled away from the beamsplitter mirror according to the embodiments of the present disclosure.

FIG. 3A illustrates a side view of the camera beamsplitter mirror assembly with the adjustable camera titled downwards onto the beamsplitter mirror according to the embodiments of the present disclosure.

FIG. 3B illustrates the side view of the camera beamsplitter mirror assembly with the adjustable camera titled away from the beamsplitter mirror according to the embodiments of the present disclosure.

FIG. 4A illustrates a front view of the camera beamsplitter mirror assembly with the adjustable camera titled downwards onto the beamsplitter mirror according to the embodiments of the present disclosure.

FIG. 4B illustrates the front view of the camera beamsplitter mirror assembly with the adjustable camera titled away from the beamsplitter mirror according to the embodiments of the present disclosure.

FIG. 5 illustrates a schematic view of the camera beamsplitter mirror assembly with the camera in a high position according to the embodiments of the present disclosure.

FIG. 6 illustrates a schematic view of the camera beamsplitter mirror assembly with the camera in a low position according to the embodiments of the present disclosure.

FIG. 7 illustrates the schematic view of the camera beamsplitter mirror assembly with the camera in an inverted position according to the embodiments of the present disclosure.

### DETAILED DESCRIPTION OF THE INVENTION

In the following description of the embodiments of the invention, reference is made to the accompanying drawings that form a part hereof, and which are shown by way of illustration of specific embodiments in which the invention may be practiced. These embodiments are described in sufficient detail to enable those skilled in the art to practice the invention, and it is to be understood that other embodiments may be utilized and that changes may be made without departing from the scope of the present invention.

The specification may refer to “an”, “one” or “some” embodiment(s) in several locations. This does not necessarily imply that each such reference is to the same embodiment(s), or that the feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries should be interpreted as having a meaning that is consistent with their meaning in the context of the relevant art and will not be interpreted in an idealized or overly formal sense unless expressly so defined herein.

The utility of the devices described herein will be explained further in detail in the following sections of this document referring to the figures. Specific terms used herein do not restrict the scope of the present disclosure.

Embodiments of the present invention disclose a camera beamsplitter mirror assembly for enhanced eye contact in digital communications.

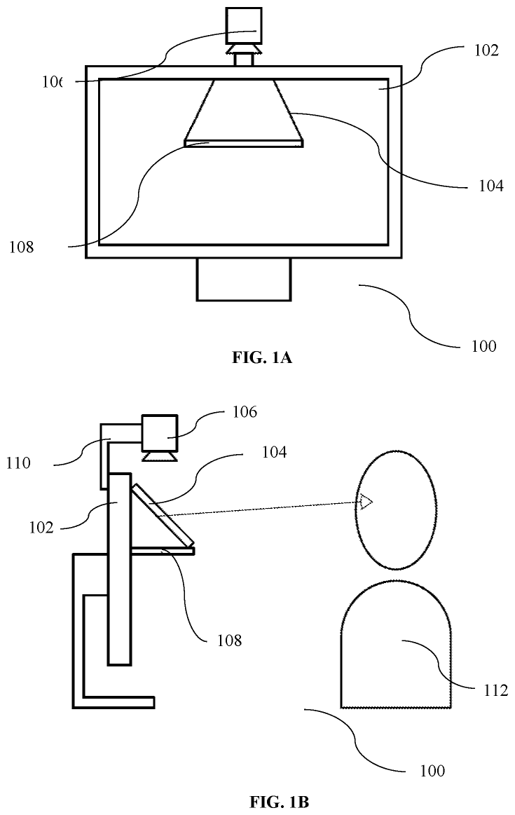

FIG. 1A illustrates a front view of a camera beamsplitter mirror assembly 100 according to the embodiments of the present disclosure. FIG. 1B is a schematic illustration of the camera beamsplitter mirror assembly 100 according to the embodiments of the present disclosure. According to an embodiment of the present invention, the camera beamsplitter mirror assembly 100 comprises of a display device 102 for displaying a plurality of information, a beamsplitter mirror 104 positioned in front of the display device 102, wherein the beamsplitter mirror 104 is adjustable to a plurality of predetermined angles and an adjustable camera 106 mounted to the display device 102 by a removable attachment means 110, wherein the adjustable camera 106 is pointed towards the reflective surface of the beamsplitter mirror 104.

According to an embodiment of the present invention, the beamsplitter mirror reflects an image of a person positioned in front of the camera beamsplitter mirror assembly to the adjustable camera.

According to an embodiment of the present disclosure, the camera beamsplitter mirror assembly 100 further comprises a background component 108 attachable to the beamsplitter mirror 104 to provide a dark background behind the reflected image for enhanced contrast, wherein the background component 108 can be adjusted to provide different colors or effects.

According to an embodiment of the present disclosure, the beamsplitter mirror 104 is positioned at the plurality of predetermined angles ranging between 15º to 65°, preferably positioned at the angle of 45°.

According to an embodiment of the present disclosure, the removable attachment means 110 comprises at least one of a clip, clamp or bracket arm to facilitate attachment to the edge of the display device 102.

According to an embodiment of the present disclosure, the display device 102 comprises at least one of a digital display screen, computer monitor, laptop display, smartphone, tablet, or an object displaying information. Further, the plurality of information comprises at least one of a textual information or a video.

According to an embodiment of the present disclosure, the adjustable camera 106 is pointed towards the reflective surface of the beamsplitter mirror 104 captures the reflection of a person 112 looking through the beamsplitter mirror 104 onto the display device 102. Further, the adjustable camera 106 and the beamsplitter mirror 104 are positioned such that the person looking through the beamsplitter mirror 104 is able to make direct eye contact with the adjustable camera 106. Furthermore, the beamsplitter mirror 104 with the adjustable camera 106 can be used without a display device 102 as any information behind the beamsplitter mirror 104 becomes visible. Also, it provides an adjustable mechanism to allow for fine-tuning of the angle of the beamsplitter mirror 104.

According to an embodiment of the present disclosure, the beamsplitter mirror 104 is independent of the type of the camera or type of the display device or shape of the beamsplitter mirror glass or ratio.

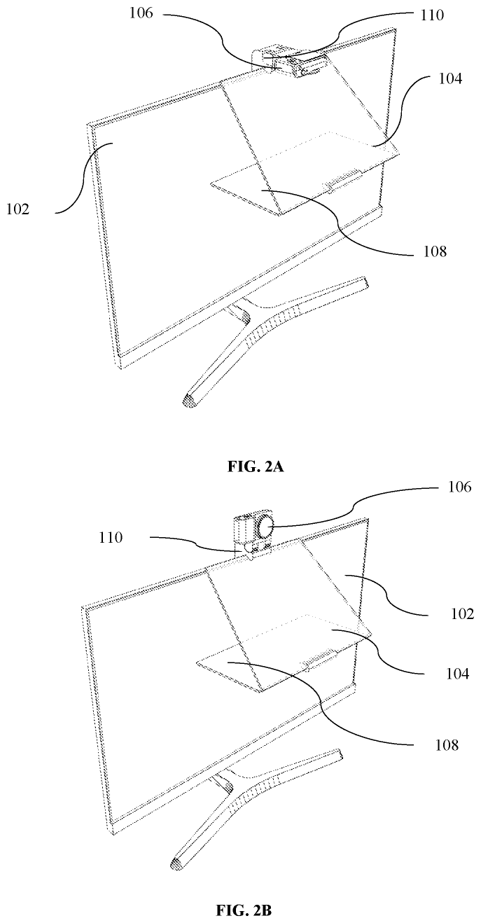

FIG. 2A illustrates a perspective view of the camera beamsplitter mirror assembly 100 with an adjustable camera 106 titled downwards onto the beamsplitter mirror 104 according to the embodiments of the present disclosure. According to an embodiment of the present invention, the beamsplitter mirror 104 is positioned in front of the display device 102 by mounting it onto the removable attachment means 110 along with the adjustable camera 104. According to an embodiment of the present invention, the beamsplitter mirror 104 along with the adjustable camera 106 can be assembled onto any side of the display device 102.

FIG. 2B illustrates the perspective view of the camera beamsplitter mirror assembly 100 with the adjustable camera 106 titled away from the beamsplitter mirror 104 according to the embodiments of the present disclosure. According to an embodiment of the present invention, the adjustable camera 106 in a downward-pointed direction onto the reflective surface of the beamsplitter mirror 104 allows capturing of eye contact of the person or object without requiring them to look directly into the camera lens. This makes it easier for the person or object to maintain eye contact with the camera 104, even if they are looking at the display device 102 or reading a script displayed on the display device 102. The adjustable camera 106 along with the beamsplitter mirror 104 can be adjusted for the optimal angle, size, and brightness of the reflected image.

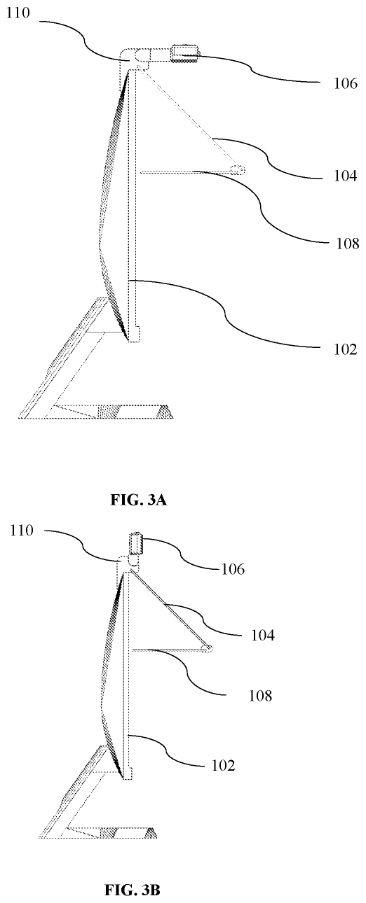

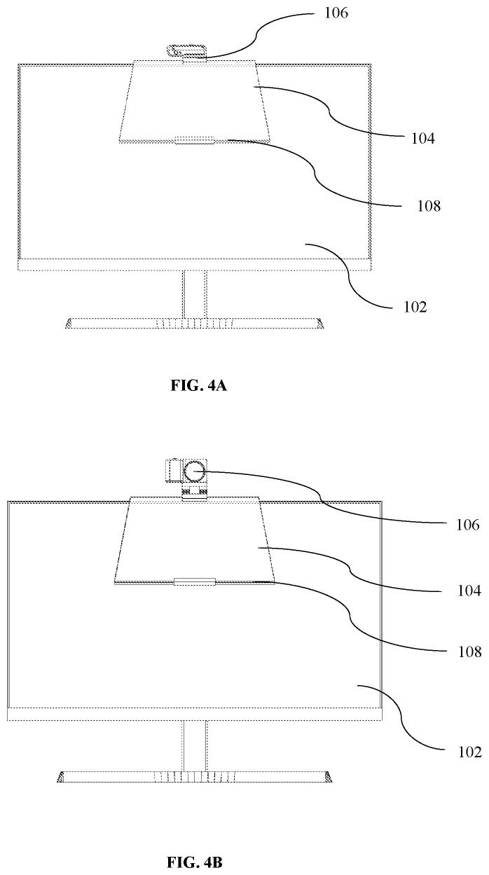

FIG. 3A illustrates a side view of the camera beamsplitter mirror assembly 100 with the adjustable camera 106 titled downwards onto the beamsplitter mirror 104 according to the embodiments of the present disclosure. FIG. 3B illustrates the side view of the camera beamsplitter mirror assembly 100 with the adjustable camera 106 titled away from the beamsplitter mirror 104 according to the embodiments of the present disclosure. FIG. 4A illustrates a front view of the camera beamsplitter mirror assembly 100 with the adjustable camera 106 titled downwards onto the beamsplitter mirror 104 according to the embodiments of the present disclosure. FIG. 4B illustrates the front view of the camera beamsplitter mirror assembly 100 with the adjustable camera 106 titled away from the beamsplitter mirror 104 according to the embodiments of the present disclosure.

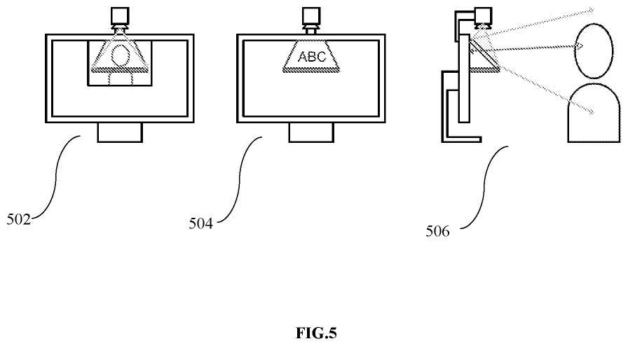

FIG. 5 illustrates a schematic view of the camera beamsplitter mirror assembly 100 with the adjustable camera 106 in a high position according to the embodiments of the present disclosure. FIG. 5 illustrates the display of the plurality of information comprising the video at 502, the textual information at 504, and the principle of working of the camera beamsplitter mirror assembly 100 at 506.

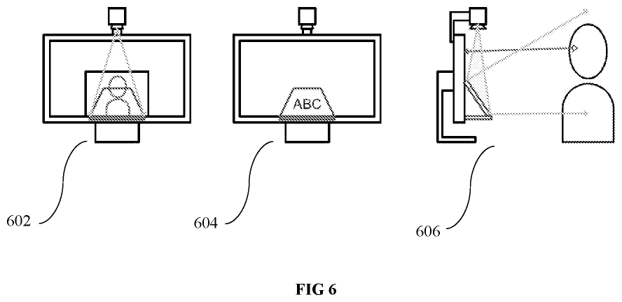

FIG. 6 illustrates a schematic view of the camera beamsplitter mirror assembly 100 with the adjustable camera 106 in a low position according to the embodiments of the present disclosure. Furthermore, FIG. 6 illustrates the display of the plurality of information comprising the video at 602, the textual information at 604, and the principle of working of the camera beamsplitter mirror assembly 100 at 606.

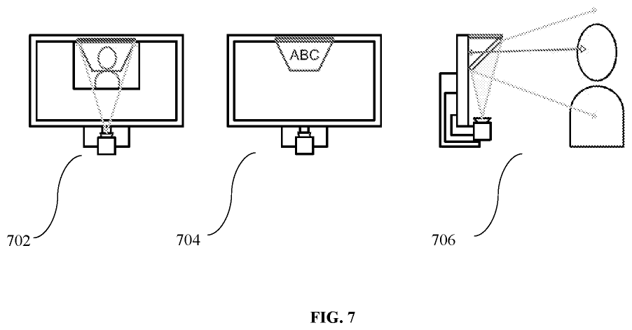

FIG. 7 illustrates the schematic view of the camera beamsplitter mirror assembly 100 with the adjustable camera 106 in an inverted position according to the embodiments of the present disclosure. According to an embodiment of the present invention, when the adjustable camera 106 is mounted at the bottom of the display device, it is positioned below the beamsplitter mirror 104 at the plurality of predetermined angles ranging between 15° to 65°, preferably positioned at the angle of 45° in front of the display device 102. This configuration allows the adjustable camera 106 to capture the reflection of the person or object that is looking beyond the beamsplitter mirror 104 and onto the display device 102. Furthermore, FIG. 7 illustrates a display of plurality of information comprising the video at 702, the textual information at 704 and the principle of working of the camera beamsplitter mirror assembly 100 at 706.

Various advantages of the present invention comprise providing enhanced eye contact, flexible and versatile set-up, no requirement for a dedicated monitor and enhanced image quality with improved communication experience. More particularly, the present invention enhances eye contact between the speaker and audience or between the participants in a video conference by capturing a reflection of the person looking through the beamsplitter mirror 104 onto the display device 102.

It may be appreciated that the camera beamsplitter assembly 100 of the present invention can be attached to any existing computer monitor or a laptop screen, making it independent of the type of the camera or monitor used, which renders the camera beamsplitter assembly 100 flexible for different types of display screens.

Furthermore, the present invention employs the adjustable camera 106 that looks down onto the reflection rather than through the beamsplitter mirror 104, providing a more natural and improved image quality. Additionally, the camera beamsplitter assembly 100 of the present invention also comprises of a background component 108 to provide better contrast for the reflected image.

Moreover, the camera beamsplitter assembly 100 of the present invention can be used as a simple accessory attachment and does not require any special skills or knowledge to use. This assembly can be used for various use cases such as but not limited to video conferencing, digital content presentation, reading scripts, eye contact with an interviewer, precise eye tracking, eye vision tests, and other tasks that require direct eye contact with the camera.

Overall, the improved eye contact and image quality provided by the camera beamsplitter assembly 100 of the present invention enhances the communication experience and provides a more natural and engaging experience for the participants in a video conference or digital content presentation.

Examples described herein can also be used in various other scenarios and for various purposes. It may be noted that the above-described examples of the present solution are for the purpose of illustration only. Although the solution has been described in conjunction with a specific embodiment thereof, numerous modifications may be possible without materially departing from the instructions and advantages of the subject matter described herein. Other substitutions, modifications, and changes may be made without departing from the spirit of the present solution. All of the features disclosed in this specification (including any accompanying claims, abstract, and drawings), and/or all of the steps of any method or process so disclosed, may be combined in any arrangement, except combinations where at least some of such features and/or steps are mutually exclusive.

The present description has been shown and described with reference to the foregoing examples. It is understood, however, that other forms, details, and examples can be made without departing from the spirit and scope of the present subject matter.

1. A camera beamsplitter mirror assembly for enhanced eye contact, comprising:
a display device for displaying a plurality of information;
a beamsplitter mirror positioned in front of the display device, wherein the beamsplitter mirror is adjustable to a plurality of predetermined angles; and
an adjustable camera mounted to the display device by a removable attachment means, wherein the adjustable camera is pointed towards the reflective surface of the beamsplitter mirror.

2. The camera beamsplitter mirror assembly as claimed in claim 1, further comprises a background component attachable to the beamsplitter mirror to provide a dark background behind the reflected image for enhanced contrast, wherein the background component can be adjusted to provide different color or effects.

3. The camera beamsplitter mirror assembly as claimed in claim 1, wherein the beamsplitter mirror is positioned at the plurality of predetermined angles ranging between 15° to 65°, preferably positioned at the angle of 45°.

4. The camera beamsplitter mirror assembly as claimed in claim 1, wherein the removable attachment means comprises at least one of a clip, clamp or bracket arm to facilitate attachment to the edge of the display device.

5. The camera beamsplitter mirror assembly as claimed in claim 1, wherein the display device comprises at least one of a digital display screen, computer monitor, laptop display, smartphone, tablet, or an object displaying information.

6. The camera beamsplitter mirror assembly as claimed in claim 1, wherein the plurality of information comprises at least one of a textual information or a video.

7. The camera beamsplitter mirror assembly as claimed in claim 1, wherein the adjustable camera pointed towards the reflective surface of the beamsplitter mirror captures the reflection of a person looking through the beamsplitter mirror onto the display device.

8. The camera beamsplitter mirror assembly as claimed in claim 1, wherein the adjustable camera and the beam splitter are positioned such that the person looking through the beamsplitter mirror is able to make direct eye contact with the adjustable camera.

9. The camera beamsplitter mirror assembly as claimed in claim 1 further can be used without a display device as any information behind the beamsplitter mirror becomes visible.

10. The camera beamsplitter mirror assembly as claimed in claim 1 further comprises of an adjustable mechanism to allow for fine-tuning of the angle of the beamsplitter mirror.

11. The camera beamsplitter mirror assembly as claimed in claim 1, wherein the beamsplitter mirror is independent of the type of the camera or type of the display device or shape of the beamsplitter mirror glass or ration.

12. The camera beamsplitter mirror assembly as claimed in claim 1, wherein the beamsplitter mirror is positioned in front of the display device by mounting it onto the removable attachment means along with the adjustable camera.

13. The camera beamsplitter mirror assembly as claimed in claim 1, wherein the beamsplitter mirror along with the adjustable camera can be assembled onto any side of the display device.
